(19) United States
(12) Patent Application Publication
(10) Pub. No.: US 2018/0255548 A1
(43) Pub. Date: Sep. 6, 2018

(54) Method of Reallocating Transmission Periods for Coexisting Wireless Modules

(71) Applicant: MEDIATEK INC., Hsin-Chu (TW)

(72) Inventors: Hao-Hua Kang, Taoyuan City (TW); Shih-Hung Liu, Hsinchu City (TW); Chia-Wei Tao, Tainan City (TW)

(21) Appl. No.: 15/450,031

(22) Filed: Mar. 6, 2017

(51) Int. Cl. H04W 72/04; H04W 4/00

(52) U.S. Cl. CPC H04W 72/0446; H04W 84/12; H04W 4/008

(57) ABSTRACT

A method of reallocating transmission periods for two coexisting wireless modules is disclosed. The method includes determining whether a first transmission period is long enough for a transmission of a first wireless module in a first window before initiating the transmission of the first wireless module; and deferring a transmission of a second wireless module and continuing the transmission of the first wireless module in a second transmission period of a second window following the first window when the first transmission period is determined to be not long enough for the transmission of the first wireless module; wherein the second transmission period and the first transmission period are two successive periods in the first window or in the second window.

### BACKGROUND

The present invention relates to a method of reallocating transmission periods for coexisting wireless modules, and more particularly, to a method which selectively defers a transmission of a wireless module for adaptively reallocating transmission periods for wireless modules coexisting in a communication apparatus, a chip, or an area.

Conventionally, multiple wireless modules may coexist in a communication apparatus, a chip, or an area but within different communication apparatuses for processing wireless signals of different wireless communication systems. In such a situation, how to efficiently distribute radio resources is an issue in the art.

For example, a communication apparatus may integrate both a BT module and a WLAN module, wherein the BT module may utilize an extended synchronous connection orientated (eSCO) profile to apply a time division duplex (TDD) scheme for cooperating with the WLAN module, and the WLAN module may utilize a CTS-to-self frame as a protection frame for clearly reserving its transmission. However, the protection frame may occupy a too large portion of a Wi-Fi dwell period (i.e. an assigned period for the transmission of the WLAN module), which results in a low transmission efficiency. Besides, if a transmission/reception packet corresponding to the WLAN module has a low data rate and/or an aggregation, the Wi-Fi dwell period may not be long enough to transmit the entire transmission/reception packet. Accordingly, the conventional Wi-Fi dwell period of the WLAN module may not be flexible to fit into all kinds of transmission/reception packets.

Therefore, it is essential to efficiently reallocate transmission periods for wireless modules coexisting in a communication apparatus, a chip, or an area but within different communication apparatuses.

### SUMMARY

Therefore, the primary objective of the present invention is to provide a method of reallocating transmission periods for coexisting wireless modules.

The present invention discloses a method for a communication apparatus. The communication apparatus comprises a first wireless module and a second wireless module. The method comprises determining whether a first transmission period is long enough for a transmission of the first wireless module in a first window before initiating the transmission of the first wireless module; and deferring a transmission of the second wireless module and continuing the transmission of the first wireless module in a second transmission period of a second window following the first window when the first transmission period is determined to be not long enough for the transmission of the first wireless module; wherein the second transmission period and the first transmission period are two successive periods in the first window or in the second window.

The present invention further discloses a communication apparatus. The communication apparatus comprises a first wireless module and a second wireless module; and a control module, comprising a central processor; and a data storage unit, coupled to the central processor, for storing a programming code; wherein the programming code instructs the central processor to execute a method of reallocating transmission periods of the second wireless module and the first wireless module, and the method comprises determining whether a first transmission period is long enough for a transmission of the first wireless module in a first window before initiating the transmission of the first wireless module; and deferring a transmission of the second wireless module and continuing the transmission of the first wireless module in a second transmission period of a second window following the first window when the first transmission period is determined to be not long enough for the transmission of the first wireless module; wherein the second transmission period and the first transmission period are two successive periods in the first window or in the second window.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a communication apparatus according to an embodiment of the invention.

FIG. 2 illustrates a flowchart of a process for reallocating transmission periods of the BT module and the WLAN module shown in FIG. 1 according to an embodiment of the invention.

FIG. 3 to FIG. 5 which illustrate different schematic diagrams of transmissions of the BT module and the WLAN module shown in FIG. 1 in different periods according to embodiments of the invention.

### DETAILED DESCRIPTION

The invention aims at reallocating transmission periods for coexisting wireless modules. The coexisting wireless modules are wireless modules coexisting in a communication apparatus, a chip, or an area but within different communication apparatuses. For illustration purpose, the following embodiment corresponds to two wireless modules coexisting in a communication apparatus, wherein one of the two wireless modules (i.e., a first wireless module) is a Wireless Local Area Network module, and the other (i.e., a second wireless module) is a Bluetooth module.

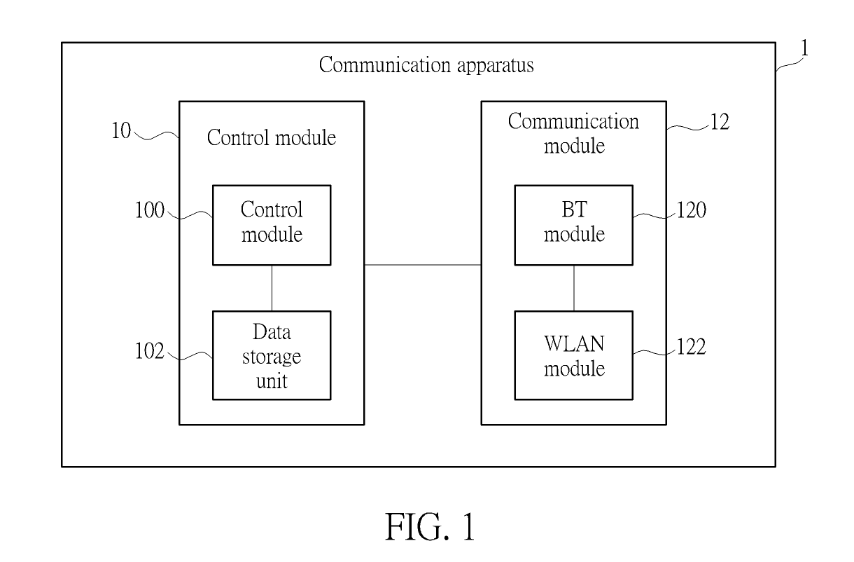

Please refer to FIG. 1, which illustrates a schematic diagram of a communication apparatus 1 according to an embodiment of the invention. In the embodiment, the communication apparatus 1 comprises a control module 10 and a communication module 12, wherein the communication module 12 comprises a Bluetooth (BT) module 120 and a Wireless Local Area Network (WLAN) module 122, and the control module 10 comprises a central processor 100 and a data storage unit 102. The data storage unit 102 is coupled to the central processor 100 for storing a programming code, which may instruct the central processor 100 to execute a method of reallocating transmission periods of the BT module 120 and the WLAN module 122. Preferably, the embodiment of the invention utilizes the eSCO profile to apply a time division duplex (TDD) for cooperating the BT module 120 and the WLAN module 122, i.e. the BT module 120 and the WLAN module 122 may sequentially process their transmission in successive transmission periods. Further, the WLAN module 122 of the embodiment may utilize the CTS-to-self frame and the network allocation vector (NAV) to negotiate with the BT module 120 for reserving its transmission, which is not limiting the scope of the invention.

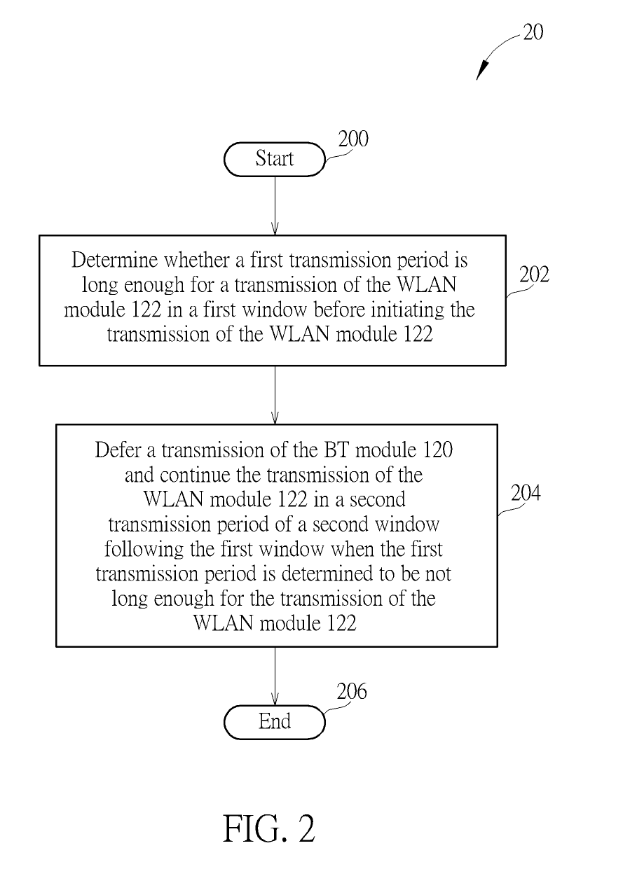

Please refer to FIG. 2, which illustrates a flowchart of a process 20 for reallocating transmission periods of the BT module 120 and the WLAN module 122 shown in FIG. 1 according to an embodiment of the invention. The process 20 may be compiled into the programming code stored in the data storage unit 102. The process 20 comprises the following steps:

Step 200: Start.

Step 202: Determine whether a first transmission period is long enough for a transmission of the WLAN module 122 in a first window before initiating the transmission of the WLAN module 122.

Step 204: Defer a transmission of the BT module 120 and continue the transmission of the WLAN module 122 in a second transmission period of a second window following the first window when the first transmission period is determined to be not long enough for the transmission of the WLAN module 122.

Step 206: End.

In Step 202, before the WLAN module 122 initiates its transmission, the control module 10 initiates a detection to determine whether the first transmission period of the first window is long enough for the transmission of the WLAN module 122. In Step 204, when the detection result of Step 202 shows that the first transmission period is not long enough for the transmission of the WLAN module 122, the control module 10 controls the BT module 120 to defer the transmission of the BT module 120 and continues the transmission of the WLAN module 122 in the second transmission period of the second window. In the embodiment, the first window and the second window may be taken as two successive and equal windows, and the second transmission period and the first transmission period are two successive periods configured inside the first window or the second window. In addition, the second transmission period is assigned to be a reserved transmission period of the BT module 120. The first transmission period is assigned to be a retransmission period of the BT module 122, or the first transmission period may also be a reserved transmission period of the WLAN module 122 if the BT module 120 is unnecessary for a retransmission.

In the first window, the embodiment of the invention may further estimate a transmission rate of the WLAN module 122 before the WLAN module 122 initiates its transmission. When the first transmission period of the first window is not long enough to finish the transmission of the WLAN module 122, the second transmission period of the second window (which is originally assigned to be utilized by the BT module 120) may be reassigned to be continuously utilized by the WLAN module 122 for finishing its transmission, and the originally scheduled transmission of the BT module 120 may be correspondingly processed after the WLAN module 122 finishes its transmission. Alternatively, after the transmission rate of the WLAN module 122 is estimated to determine that the first transmission period is long enough to finish the transmission of the WLAN module 122, the BT module 120 may maintain its scheduled transmission in the second transmission period of the second window. Accordingly, the embodiment of the invention dynamically monitors the transmission amount of the WLAN module 122 in the first transmission period of the first window, to adaptively reassign/maintain the second transmission period for the transmission of the WLAN module 122 or the BT module 120, so as to ensure that the WLAN module 122 is able to finish its entire transmission. Thus, even though the transmission/reception packet of the WLAN module 122 has a low data rate and/or an aggregation, the embodiment of the invention is capable of dynamically adjusting transmission periods for the communication apparatus 12 which simultaneously supports both operations of the BT module 120 and the WLAN module 122. Note that, various realizations of the process 20 may be applied to different packet types utilized by the BT module 120.

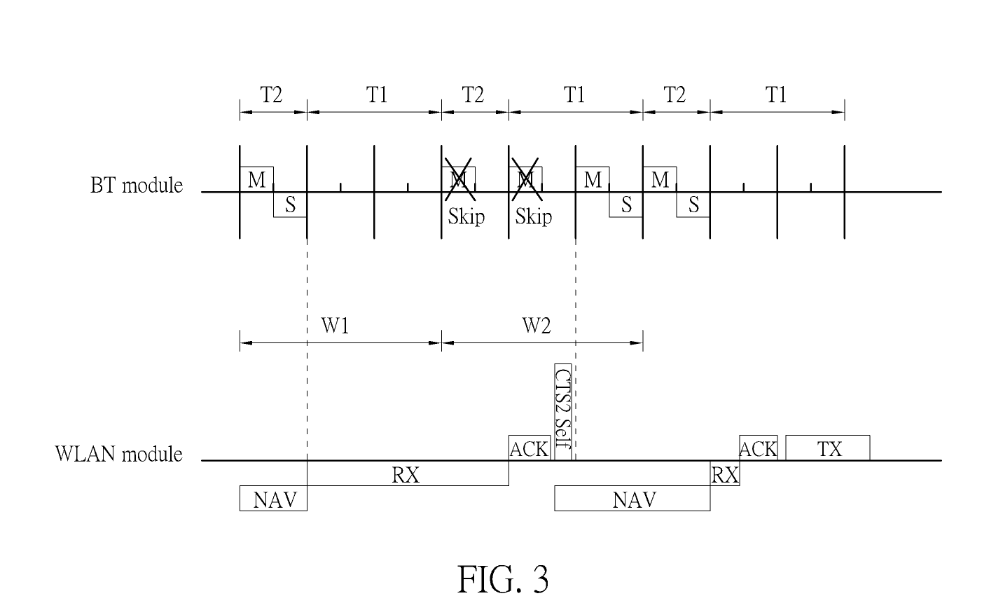

Please refer to FIG. 3, which illustrates a schematic diagram of transmissions of the BT module 120 and the WLAN module 122 in different periods according to an example of the invention. In the example, the BT module 120 is a master device to comply with an EV3 packet type, and enables zero retransmission when the BT module 120 is deferred to the last two slots of the second window W2. Accordingly, a first transmission period T1 corresponds to four slots and a second transmission period T2 corresponds to two slots in a first window W1 or in a second window W2. Under such circumstances, when the first transmission period T1 is determined to be not long enough for finishing the transmission of the WLAN module 122 in the first window W1, the transmission of the BT module 120 (e.g. actively transmitting information to a slave device) may be deferred to the last two slots of the second window W2. After the WLAN module 122 finishes the transmission in the first transmission period T1 in the first window W1, the WLAN module 122 continues the transmission in the second transmission period T2 of the second window W2, i.e. the WLAN module 122 may utilize not only the first transmission period T1 of the first window W1 but also the second transmission period T2 of the second window W2 for its transmission (e.g. a reception RX shown in FIG. 3). Thus, there is no break of the transmission of the WLAN module 122.

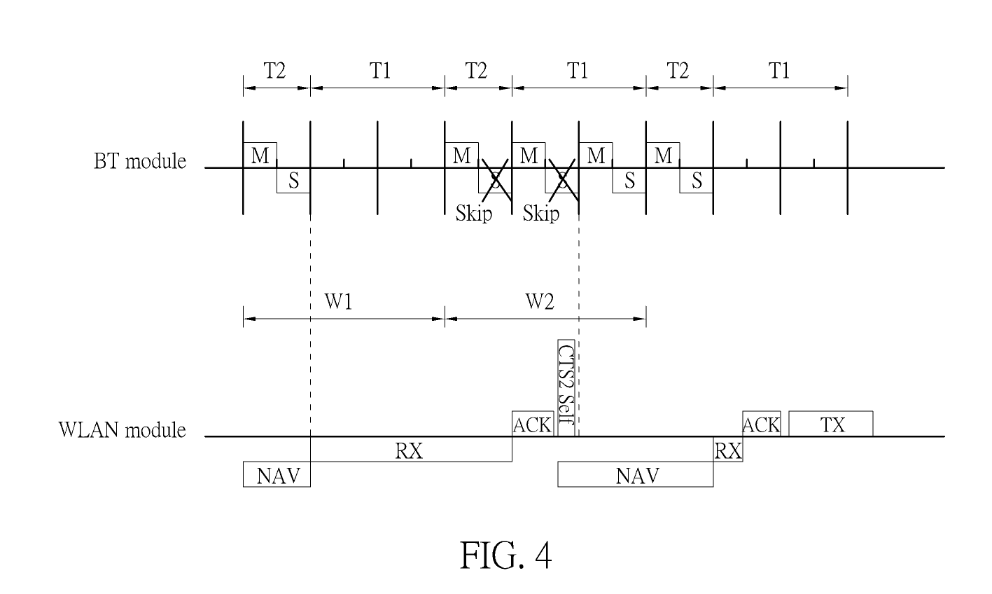

Please refer to FIG. 4, which illustrates another schematic diagram of transmissions of the BT module 120 and the WLAN module 122 in different periods according to an example of the invention. In the example shown in FIG. 4, the BT module 120 is a slave device, which also complies with the EV3 packet type with zero retransmission when the BT module 120 is deferred to the last two slots of the second window W2. Similarly, when the first transmission period T1 is determined to be not long enough for finishing the transmission of the WLAN module 122 in the first window W1, the transmission of the BT module 120 (e.g. passively receiving information from a master device) may be deferred to the last two slots of the second window W2. Accordingly, the WLAN module 122 may utilize both the first transmission period T1 of the first window W1 and the second transmission period T2 of the second window W2 to finish its transmission (e.g. a reception RX shown in FIG. 4), so as to finish its entire transmission in a successive transmission period.

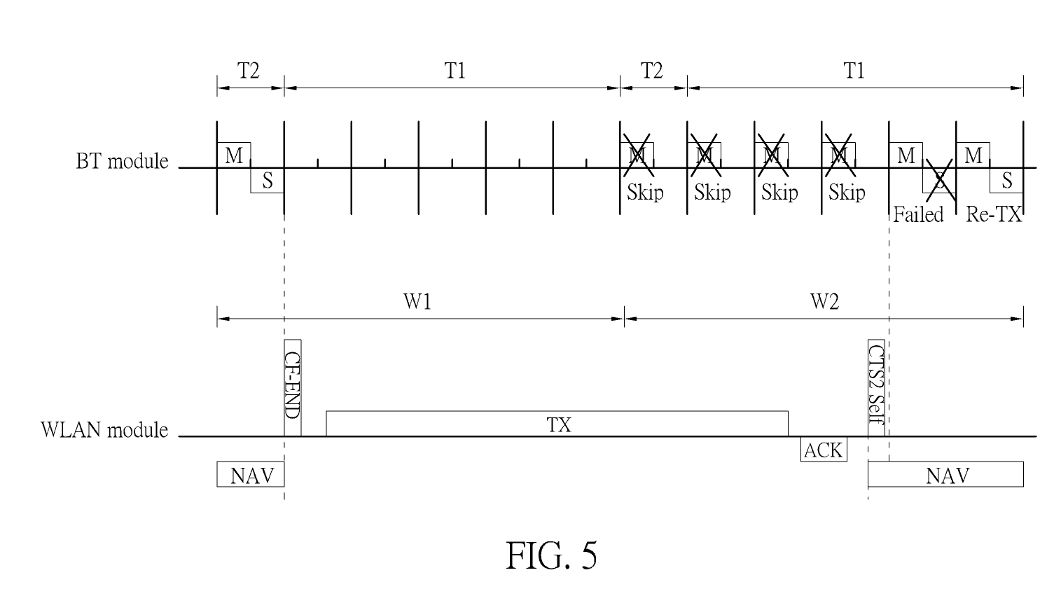

Please refer to FIG. 5, which illustrates a schematic diagram of transmissions of the BT module 120 and the WLAN module 122 in different periods according to an example of the invention. In the example shown in FIG. 5, the BT module 120 is a master device to comply with a 2-EV3 packet type, and enables one retransmission when BT module 120 is deferred to the last four slots of the second window W2. Accordingly, the first transmission period T1 corresponds to ten slots and the second transmission period T2 corresponds to two slots. Similarly, when the first transmission period T1 is determined to be not long enough for finishing the transmission of the WLAN module 122 in the first window W1, the transmission of the BT module 120 (e.g. actively transmitting information to a slave device) may be deferred to the last two slots of the second window W2 (i.e. processing the retransmission of the BT module 120). Accordingly, the WLAN module 122 may utilize the first transmission period T1 of the first window W1, the second transmission period T2 of the second window W2 and partial of the first transmission period T1 of the second window W2 to finish its transmission (e.g. a transmission TX shown in FIG. 5), such that the entire transmission of the WLAN module 122 may not be interrupted.

Noticeably, the examples of the invention show different packet types utilized by the BT module 120 with zero or one retransmission, such that the BT module 120 of the invention is controlled to adaptively defer its transmission (e.g. actively transmitting to a slave device or passively receiving from a master device), so as to allow the coexisting WLAN module 122 to finish its transmission (e.g. RX or TX) within a successive transmission period disposed in different windows. Certainly, those skilled in the art may adaptively adjust/modify/change the embodiments with other deferring/reserving mechanisms to extend the transmission period of the WLAN module 122, which is also within the scope of the invention. In addition, if the WLAN module 122 finishes its transmission within the originally assigned transmission period (i.e. it is unnecessary for the BT module 120 to defer its transmission), the embodiment of the invention may maintain the scheduled transmission period for the BT module 120 without initiating the deferring operation, so as to provide a dynamical adjustment complying with different packet types, which is also within the scope of the invention.

In summary, the embodiment of the invention provides a method which selectively defers a transmission of the BT module for adaptively reallocating transmission periods for the BT module and the WLAN module coexisting in the same communication apparatus. Accordingly, even if a low data rate with/without aggregation corresponding to the WLAN module is inevitable, the communication apparatus, supporting both operations of the WLAN module and the BT module, may be functionally operated to spare the successive transmission period for the entire transmission of the WLAN module, so as to facilitate the application of the communication apparatus.

Note that, the above embodiment corresponds to a communication apparatus including coexisting BT and WLAN modules. Accordingly, the invention may apply to any communication system including wireless modules coexisting in a communication apparatus, a chip, or an area but within different communication apparatuses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a communication apparatus, wherein the communication apparatus comprises a first wireless module and a second wireless module, the method comprising:
determining whether a first transmission period is long enough for a transmission of the first wireless module in a first window before initiating the transmission of the first wireless module; and
deferring a transmission of the second wireless module and continuing the transmission of the first wireless module in a second transmission period of a second window following the first window when the first transmission period is determined to be not long enough for the transmission of the first wireless module;
wherein the second transmission period and the first transmission period are two successive periods in the first window or in the second window.

2. The method of claim 1, wherein the second transmission period is a reserved transmission period of the second wireless module.

3. The method of claim 1, wherein the first transmission period is a retransmission period of the second wireless module, or the first transmission period is a reserved transmission period of the first wireless module if the second wireless module is unnecessary for a retransmission.

4. The method of claim 1, further comprising maintaining the transmission of the second wireless module in the second transmission period of the second window when the first transmission period is determined to be long enough for the transmission of the first wireless module.

5. The method of claim 1, further comprising estimating a transmission rate of the first wireless module before determining whether the first transmission period is long enough for the transmission of the first wireless module in the first window before initiating the transmission of the first wireless module.

6. The method of claim 1, wherein the first transmission period corresponds to four slots and the second transmission period corresponds to two slots, and the second wireless module complies with an EV3 packet type.

7. The method of claim 1, wherein the first transmission period corresponds to ten slots and the second transmission period corresponds to two slots, and the second wireless module complies with a 2-EV3 packet type.

8. The method of claim 1, wherein the first wireless module is a Wireless Local Area Network (WLAN) module.

9. The method of claim 1, wherein the second wireless module is a Bluetooth (BT) module.

10. A communication apparatus, comprising:
a first wireless module and a second wireless module; and
a control module, comprising:
a central processor; and
a data storage unit, coupled to the central processor, for storing a programming code;
wherein the programming code instructs the central processor to execute a method of reallocating transmission periods of the second wireless module and the first wireless module, and the method comprises:
determining whether a first transmission period is long enough for a transmission of the first wireless module in a first window before initiating the transmission of the first wireless module; and
deferring a transmission of the second wireless module and continuing the transmission of the first wireless module in a second transmission period of a second window following the first window when the first transmission period is determined to be not long enough for the transmission of the first wireless module;
wherein the second transmission period and the first transmission period are two successive periods in the first window or in the second window.

11. The communication apparatus of claim 10, wherein the second transmission period is a reserved transmission period of the second wireless module.

12. The communication apparatus of claim 10, wherein the first transmission period is a retransmission period of the second wireless module, or the first transmission period is a reserved transmission period of the first wireless module if the second wireless module is unnecessary for a retransmission.

13. The communication apparatus of claim 10, wherein the method further comprises maintaining the transmission of the second wireless module in the second transmission period of the second window when the first transmission period is determined to be long enough for the transmission of the first wireless module.

14. The communication apparatus of claim 10, the method further comprises estimating a transmission rate of the first wireless module before determining whether the first transmission period is long enough for the transmission of the first wireless module in the first window before initiating the transmission of the first wireless module.

15. The communication apparatus of claim 10, wherein the first transmission period corresponds to four slots and the second transmission period corresponds to two slots, and the second wireless module complies with an EV3 packet type.

16. The communication apparatus of claim 10, wherein the first transmission period corresponds to ten slots and the second transmission period corresponds to two slots, and the second wireless module complies with a 2-EV3 packet type.

17. The method of claim 10, wherein the first wireless module is a Wireless Local Area Network (WLAN) module.

18. The method of claim 10, wherein the second wireless module is a Bluetooth (BT) module.
